(19) United States
(12) Patent Application Publication
(10) Pub. No.: US 2025/0294635 A1
(43) Pub. Date: Sep. 18, 2025

(54) SIGNALING MAXIMUM SETUP LINK LIMIT

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/077,841

(22) Filed: Mar. 12, 2025

Related U.S. Application Data
(60) Provisional application No. 63/564,340, filed on Mar. 12, 2024.

(51) Int. Cl. H04W 76/18; H04W 72/0446; H04W 76/15

(52) U.S. Cl. CPC H04W 76/18; H04W 72/0446; H04W 76/15

(57) ABSTRACT

The present disclosure provides techniques for signaling the maximum setup link limit. An access point multi-link device (AP MLD) receives an association request frame from a non-AP station (STA), the association request frame requesting to establish a set of links between the AP MLD and the non-AP STA. The AP MLD determines that accepting the set of requested links would result in a total number of established links exceeding a limit set by the AP MLD for the non-AP STA. In response to the determination, the AP MLD selects a subset of the set of requested links, where the total number of established links does not exceed the limit, and transmits an association response frame to the non-AP STA, the association response frame comprising a status code indicating that at least one requested link is rejected due to exceeding the limit.

### CROSS-REFERENCE TO RELATED APPLICATIONS

This application claims benefit of co-pending U.S. provisional patent application Ser. No. 63/564,340 filed Mar. 12, 2024. The aforementioned related patent application is herein incorporated by reference in its entirety.

### TECHNICAL FIELD

Embodiments presented in this disclosure generally relate to wireless communication. More specifically, embodiments disclosed herein relate to signaling the maximum setup link limit by access point multi-link devices (AP MLDs) to connected non-AP MLDs.

### BACKGROUND

In multi-link operation (MLO), an AP MLD can set up multiple links with a non-AP MLD. These links can operate across different frequency bands, such as one in 2.4 GHz, one in 5 GHZ, and one in 6 GHz. The multi-link setup allows data to be sent faster, reduces delays, and improves the connection stability. However, the number of links between an AP MLD and a non-AP MLD cannot be unlimited. If left unrestricted, a non-AP MLD could set up a large number of links, leaving fewer resources for other devices and causing unfair access. In addition, each link requires significant overhead, including the exchange of control message, coordination between links, and ongoing management to maintain proper operation. If a non-AP MLD establishes too many links, the AP needs to handle increased control traffic, which can strain network resources and reduce overall efficiency.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example (Re)Association Response frame with a status code indicating that at least one requested link is rejected due to exceeding the allowable setup link limit, according to some embodiments of the present disclosure.

FIG. 2 depicts an example (Re)Association Response frame with a status code indicating full acceptance of the requested links, according to some embodiments of the present disclosure.

FIG. 3 depicts an example Link Reconfiguration frame with a status code indicating that at least one requested link is rejected due to exceeding the allowable setup link limit, according to some embodiments of the present disclosure.

FIG. 4 depicts an example Link Reconfiguration frame with a status code indicating full acceptance of the requested links, according to some embodiments of the present disclosure.

FIG. 5 depicts a set of interactions between a non-AP MLD and an AP MLD, where the non-AP MLD learns the maximum allowable link limit by processing the Association Response frame, according to some embodiments of the present disclosure.

FIG. 6 depicts a set of interactions between a non-AP MLD and an AP MLD, where the non-AP MLD learns the maximum allowable link limit by processing the Association Response frame and Link Reconfiguration Response frame, according to some embodiments of the present disclosure.

FIG. 7 depicts an example method of an AP MLD processing (Re)Association and Link Reconfiguration Request frames and sending responses to signal the maximum allowable link limit, according to some embodiments of the present disclosure.

FIG. 8 depicts an example method of a non-AP MLD determining the maximum allowable link limit by processing (Re)Association and Link Reconfiguration Response frames from the AP MLD, according to some embodiments of the present disclosure.

FIG. 9 is a flow diagram depicting an example method for signaling a maximum allowable link limit, according to some embodiments of the present disclosure.

FIG. 10 depicts an example network device configured to perform various aspects of the present disclosure, according to some aspects of the present disclosure.

FIG. 11 depicts an example non-AP device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by an access point multi-link device (AP MLD) from a non-AP station (STA), an association request frame, the association request frame requesting to establish a set of links between the AP MLD and the non-AP STA, determining, by the AP MLD, whether accepting the set of requested links would result in a total number of established links exceeding a limit set by the AP MLD for the non-AP STA, in response to determining that accepting the set of requested links would result in the total number of established links exceeding the limit, selecting, by the AP MLD, a subset of the set of requested links, where the total number of established links does not exceed the limit, and transmitting, by the AP MLD, an association response frame to the non-AP STA, the association response frame comprising a status code indicating that at least one requested link is rejected due to exceeding the limit.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

In MLO, the number of links that can be established is often not unlimited. An AP MLD may enforce a policy that limits the number of links it allows for a specific non-AP MLD, even if the AP can support a higher number of links. For example, an AP MLD may decide to establish only three links with a specific non-AP MLD, even though it has the capability to support more than three links. This helps in efficiently managing resources across multiple associated non-AP MLDs. When such a policy is defined, the AP may reject some links requested during ML setup or ML reconfiguration operations.

Embodiments of the present disclosure introduce methods, systems, and apparatuses for AP MLD processing ML setup and link reconfiguration requests from associated STAs and signaling the policy limit within response messages. In one embodiment, a status code, such as REJECTED_MAX_ALLOWED_SETUP_LINKS_LIMIT_REACHED or REJECTED_MAX_SETUP_LINKS_LIMIT_REACHED, may be included within the AP MLD's responses. This code indicates that one or more requested links are rejected for the non-AP MLD because the maximum number of allowed setup links has been reached at the AP MLD for that non-AP MLD, and accepting the link would exceed this limit.

In one embodiment, the status code may be used in an Association Response frame and/r or a re-association response frame when accepting all requested links from the non-AP MLD would exceed the maximum number of setup links (e.g., 3) allowed for the non-AP MLD. In some embodiments, additional conditions may be added to further limit the use of the rejection code, such as that the AP MLD advertises more than a predefined threshold number of links (e.g., 3); the non-AP MLD requests more links than a second predefined threshold (e.g., 3); the number of currently accepted links at the AP MLD exceeds a defined threshold (e.g., 3). These additional conditions prevent the AP MLD from misusing the rejection code and ensure that the policy-limiting strategy is applied only when it benefits the overall network system (e.g., when AP advertises a sufficient number of links, STAs are requesting more links than a reasonable range, and the AP MLD has already established a number of links and cannot accommodate addition ones without exceeding its policy-defined limit).

In the embodiment of a Link Reconfiguration Response frame, the status code may only be used when accepting the requested additional links would cause the total number of established links for the non-AP MLD to exceed a predefined limit (e.g., 3), or, during the ML reconfiguration transition phrase, the total number of links to be supported by the AP MLD (including the existing setup links, the links requested for deletion, and the links requested for addition) exceeds the limit set by the AP MLD.

Upon receiving the response frame with the rejection status code, in one embodiment, the non-AP MLD infers the maximum allowable link limit enforced by the AP MLD. The non-AP MLD may determine this limit based on the number of accepted links in the response. When the status code is included within the Association Response frame (or Reassociation response frame), the inferred limit is equal to the number of links accepted in the response. When the status code appears within the Link Reconfiguration Response frame, the inferred limit is calculated as the sum of the initially established links, plus any additional links accepted in the reconfiguration response, minus any links deleted in the reconfiguration response. By determining this limit, the non-AP MLD may adjust future association requests or link reconfiguration requests accordingly.

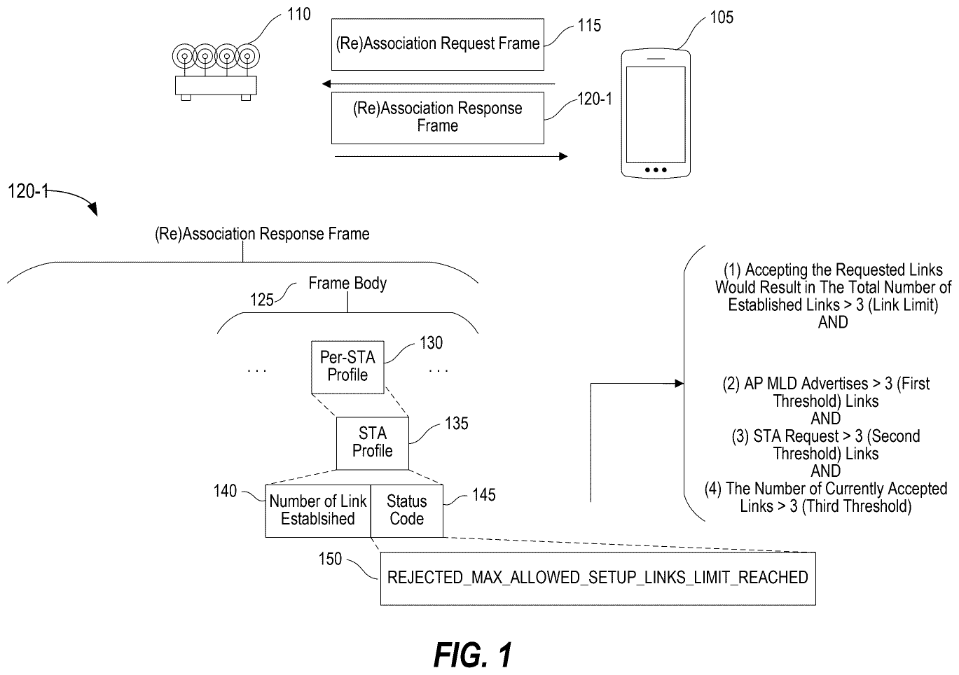

FIG. 1 depicts an example (Re)Association response frame 120-1 with a status code 150 indicating that at least one requested link is rejected due to exceeding the allowable setup link limit, according to some embodiments of the present disclosure. In some embodiments of the present disclosure, “(Re) Association” and similar terms refers to both “association” as well as “re-association.” For example, a “(re) association response frame” may refer to an “association response frame,” a “re-association response frame,” or both. Similarly, in some aspects, “association” may refer to an initial association and/or a re-association.

As depicted, the station (STA) MLD 105 initiates an association process by sending an (Re)Association Request frame 115 to the AP MLD 110. The request 115 may include an intent to establish multiple links between the STA MLD 105 and the AP MLD 110. The AP MLD 110 processes the request and sends a (Re) Association Response frame, indicating whether the requested links are approved and which links have been successfully established.

As used herein, the AP MLD 110 may correspond to any network device capable of managing multiple STAs and supporting multi-link operation. The AP MLD 110 may enforce a policy that defines a limit on the number of links that can be established with a particular STA. When the number of requested links exceeds this limit, the AP MLD 110 rejects one or more requested links and communicates this information to the STA MLD 105.

A status code 150 is used for rejection. The status code 150 may be represented as REJECTED_MAX_ALLOWED_SETUP_LINKS_LIMIT_REACHED, REJECTED_MAX_SETUP_LINKS_LIMIT_REACHED, or any other suitable format. The status code 150 indicates that one or more requested links are rejected due to reaching the maximum allowed setup link limit for that STA.

As depicted in FIG. 1, since the status code 150 is used to communicate that the requested links exceed the defined limit, the code is included in the response only when accepting the requested links would exceed the maximum allowable setup limit set by the AP MLD 110. If this condition is met, the AP MLD 110 includes the status code 150, indicating that at least one requested link was rejected due to reaching the link limit.

In some embodiments, to further refine the signaling behavior and avoid unnecessary use of the status code, additional conditions may be imposed to restrict when the rejection code 150 is included. These conditions include: (1) the AP MLD 110 advertises links more than a first defined threshold (e.g., 3); (2) the STA MLD 105 requests a number of links more than a second defined threshold (e.g., 3); and (3) the total number of links already established or accepted by the AP MLD 110 reaches a third defined threshold (e.g., 3). If the AP MLD 110 supports a small number of links (e.g., less than 3 links), enforcing a link limit may be unnecessary, and using the status code 150 may be redundant. In embodiments when the STA MLD 105 requests fewer links than the second threshold (e.g., 3), the AP MLD 110 may not need to enforce a rejection, as the request remains within a reasonable range. If the number of already accepted links at the AP MLD 110 is very small (e.g., less than 3 links), there is still room to establish additional links, and enforcing a link limit may be unnecessary. These additional conditions help to reduce unnecessary signal overhead and improve network efficiency. The limited use of the reason code 150 ensures that the link limiting policy is enforced when the network environment and available resources support its enforcement, such as when the AP MLD 110 advertises a sufficient number of links, the STA MLD requests links exceeding a reasonable range, and the total number of established link has reached a defined level and cannot accommodate additional ones without exceeding its policy-defined limit.

As a result, in this configuration, the status code 150 may be used only when all four conditions are met. For example, the rejection status code 150 is included when the AP advertises more links than the first defined threshold (e.g., 3), the STA MLD requests more links than the second defined threshold (e.g., 3), the total number of links already accepted by AP MLD 110 reaches the third defined threshold (e.g., 3), and accepting all requested link in the request would result in the total number of established links exceeding the AP MLD's policy-defined limit.

If any of these conditions are not met, the AP MLD 110 does not include the rejection status code. For example, if the AP MLD 110 advertises fewer links than the first defined threshold (e.g., 3), the rejection status code 150 is not used. If the AP MLD 110 advertises links more than the first defined threshold, but the STA MLD 105 requests a number of links less than the second threshold (e.g., 3), the rejection status code 150 is not used. If the AP MLD 110 advertises links more than the first defined threshold, and the STA MLD 105 requests a number of links that exceeds the second threshold, but the number of currently accepted links at the AP MLD has not yet reached the third threshold (e.g., 3), the rejection status code 150 is not used because there is still room to establish additional links. If the AP MLD 110 advertises links more than the first defined threshold, the STA MLD 105 requests a number of links that exceeds the second threshold, and the number of currently accepted links at the AP MLD has reached the third threshold (e.g., 3), but accepting all requested links has not yet reached the maximum setup link limit, the rejection code is not used because accepting all requested links would not violate the link limit policy.

The first, second, and third thresholds, as well as the maximum allowable setup link limit, may be adjusted by AP MLD 110 based on various factors, such as network load, resource availability, AP policy settings, or quality of service (QOS) requirements. In some embodiments, the allowable link limit may be generic for all STAs within the same basic service set (BSS). For example, every STA is restricted to a maximum of three links. In other embodiments, the limit may be specific to each STA. For example, STA 1 is allowed only two links, while STA 2 is allowed three links.

As depicted in FIG. 1, the (Re)Association Response frame 120-1 includes a Frame Body 125, which includes several elements. Within the Frame Body 125, there is a Per-STA Profile subelement 130, which includes an STA Profile field 135. Within the STA Profile field 135, two subfields are included: the Number of Links Established field 140, and the Status Code field 145. The Number of Links Established field 140 indicates how many links have been successfully set up for the STA MLD 105, and the Status Code field 145 includes the link setup status. If the AP MLD 110 determines that one or more requested links should be rejected due to exceeding the setup link limit, the status code 150, such as REJECTED_MAX_ALLOWED_SETUP_LINKS_LIMIT_REACHED, is included in the Status Code field 145 of the (Re)Association Response frame 120-1.

Upon receiving the (Re)Association Response frame 120-1, the STA MLD 105 determines the maximum allowable link limit by interpreting the Status Code field 145 and the Number of Links Established field 140 included in the response. The Number of Links Established field specifies how many links have been successfully set up between the STA MLD 105 and the AP MLD 110, and the Status Code field indicates whether all requested links have been approved and successfully established, or whether any requested links are rejected due to exceeding the AP's setup link limit. When the rejection code 150 (REJECTED_MAX_ALLOWED_SETUP_LINKS_LIMIT_REACHED) is included, the STA MLD 105 recognizes that at least one requested link was rejected due to the maximum setup link limit (e.g., 3 links) being reached. In this configuration, the maximum allowable link limit is inferred as the number of links indicated in the Number of Links Established field 140. For example, if the STA MLD 105 requested five links, but the response 120-1 includes the rejection status code 150 and the Number of Links Established field 140 indicates three links, the STA MLD 105 determines that the AP MLD 110 enforces a limit of three links specific to the STA MLD 105.

In some embodiments, upon determining the maximum allowable link limit, the STA MLD 105 may use the information to adjust future requests. When sending a Link Reconfiguration Request frame and/or a Reassociation Request frame, the STA MLD 105 provides that the total number of requested links is less than or equal to the inferred limit. By doing so, unnecessary request rejections may be avoided, which further reduces signaling overhead and optimizes link management.

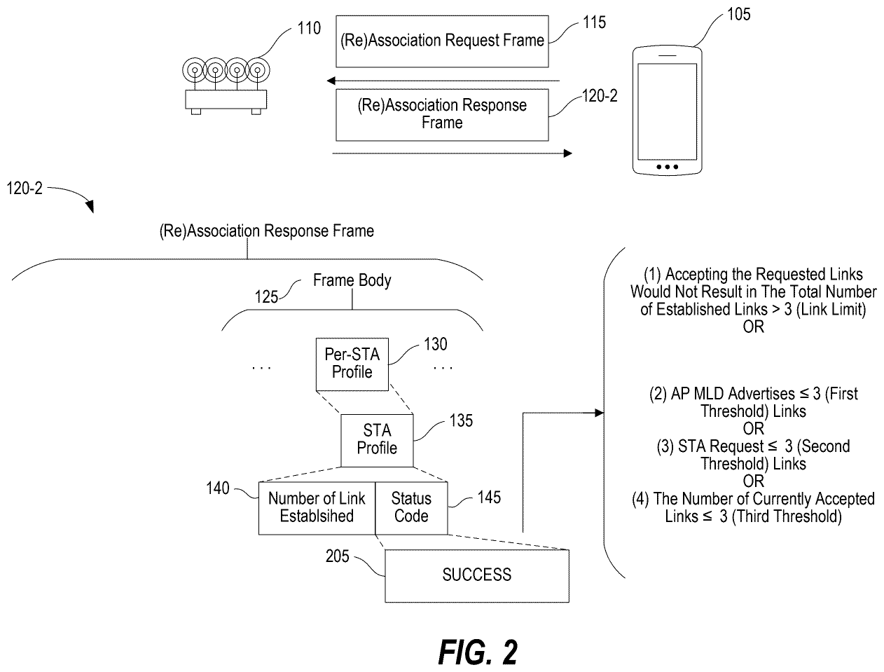

FIG. 2 depicts an example (Re)Association Response frame 120-2 with a status code 205 indicating full acceptance of the requested links, according to some embodiments of the present disclosure.

As depicted, the (Re)Association Response frame 120-2 includes a SUCCESS status code 205. This code is used to indicate that all requested links have been fully accepted, and no requested links have been rejected. When the AP MLD 110 enforces a policy-based link limit, the SUCCESS status code 205 is sent when accepting the requested link does not result in the total number of established links for the STA MLD 105 exceeding the predefined link limit (e.g., 3).

In some embodiments, the SUCCESS status code 205 may also be used when the link limiting policy is not enforced due to limited advertised links and available resources. For example, when the AP MLD 110 advertises a small number of links, less than or equal to a first threshold (e.g., 3 links), enforcing a strict link limit is not desired (or necessary) since the total number of available links is already constrained. Even if no explicit per-STA limit is applied, the AP inherently controls the overall link distribution by restricting the total number of advertised links. In this configuration, the SUCCESS status code 205 may be used when all requested links are approved and established within the available advertised links.

In some embodiments, the link limiting policy may not be enforced when the STA MLD 105 requests a small number of links, less than or equal to a second threshold (e.g., 3). In this configuration, enforcing a policy limit is redundant because the requested links remain within a reasonable range and do not pose a risk of abusing network resources. The SUCCESS status code may be used to confirm that all requested links have been accepted.

In embodiments where the total number of links already accepted and established by AP MLD 110 is below a third threshold (e.g., 3 links), the policy limit may not be enforced. If the STA MLD 105 has not yet reached a number of established links, there is no immediate need to impose a strict limit, as additional links can still be accommodated within the AP's resource allocation strategy. In these situations, the AP MLD 110 may grant the requested links without restriction and includes the SUCCESS code 205 in the response 120-2.

Although the SUCCESS status code 205 is included to confirm that all requested links have been accepted and established, the STA MLD 105 cannot infer the maximum allowable link limit from this response alone. Since the SUCCESS code 205 only indicates full acceptance of the request, it does not provide any explicit information about whether the requested number of links is close to, at, or well below the AP MLD's enforced limit. For example, if the STA MLD 105 requests three links and receives a response with the SUCCESS status code 205, it only knows that the request was granted in full. However, the AP MLD 110 may have allowed up to four or five links, or it may have had a strict limit of three. Because there is no rejection in this response, the STA MLD 105 cannot determine whether additional links would be accepted in future requests or if it has already reached the maximum limit set by the AP MLD 110.

To infer the maximum allowable link limit, the STA MLD 105 may monitor future communication with the AP MLD 110, such as Link Reconfiguration Response frame (when requesting to add more links) or Reassociation Response frame (when requesting more links than in the initial association). If a rejection code such as REJECTED_MAX_ALLOWED_SETUP_LINKS_LIMIT_REACHED is received, the STA MLD 105 can determine, at that time, that the enforced link limit is equal to the number of links established in the Reassociation Response frame, or equal to the sum of links added in the Link Reconfiguration Response frame and the number of links established in the initial Association Response frame. The STA MLD 105 may use the limit to adjust future link requests to avoid unnecessary request failures.

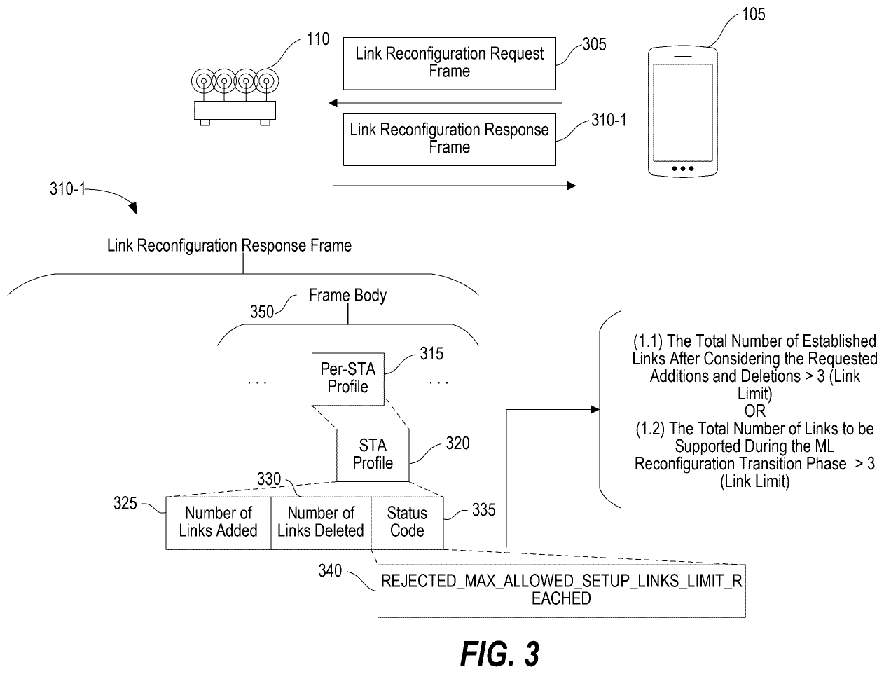

FIG. 3 depicts an example Link Reconfiguration frame 310-1 with a status code 340 indicating that at least one requested link is rejected due to exceeding the allowable setup link limit, according to some embodiments of the present disclosure.

The Link Reconfiguration Request/Response frames are used after an initial link setup when a non-AP MLD 105 (also referred to in some embodiments as STA MLD) seeks to modify its existing link configuration. These frames allow the STA MLD 105 to request changes, such as adding new links, deleting existing links, or making other adjustments to improve network performance and resource allocation.

As depicted in FIG. 3, the STA MLD 105 first sends a Link Reconfiguration Request frame 310-1 to AP MLD 110. The request includes details such as the number of links the STA MLD 105 intends to add, the number of links the STA MLD 105 intends to delete, and other configuration parameters related to MLO. Upon receiving the request, AP MLD 110 reviews the requested modifications and determines whether they comply with its link setup policies. The AP MLD 110 then responds with a Link Reconfiguration Response frame 310, which includes the number of links that have been successfully added, the number of links that have been deleted, and a status code indicating whether all or only some of the requested changes were accepted.

As discussed above, the AP MLD 110 may have a predefined maximum number of links it allows per STA. When the requested modifications (including adding new links and/or deleting existing links) would cause the total number of established link to exceed the limit (e.g., 3), the AP MLD 110 rejects at least some of the additions and communicates this information to the STA MLD 105. The status code 340 is used for rejection. The code status 340 may be represented as REJECTED_MAX_ALLOWED_SETUP_LINKS_LIMIT_REACHED or REJECTED_MAX_SETUP_LINKS_LIMIT_REACHED.

In some embodiments, the AP may consider not just the final number of established links but also the number of links temporarily maintained during the reconfiguration transition process. Specifically, the AP MLD 110 may evaluate the number of existing setup links that are not requested for deletion, the number of setup links that are requested for deletion, and the number of setup links requested for addition. If the total number of these links during the transition phase exceeds a predefined threshold, the rejection code 340 is used. The stricter rule may be used in embodiments where AP resources are constrained or where maintaining temporary link states during the reconfiguration process could lead to excessive resource usage. For example, in high-traffic environments or heavily loaded networks, the AP MLD 110 may enforce the stricter evaluation rules and prevent excessive temporary link configurations to maintain stability and efficiency.

When either of these two conditions is met (e.g., the total number of established links after considering additions and deletions would exceed the AP's setup link limit, or the total number of links during the transition phase would exceed the limit), the rejection status code 340 is included in the response, indicating that at least one of the requested links has been rejected. However, the use of this status code does not represent that the AP MLD 110 rejects all requested links. The AP MLD 110 may still accept and establish some links as long as the total number does not exceed the enforced limit. For example, if the STA MLD 105 currently has three links, the AP MLD's limit is four, and the STA MLD 105 requests to add two more links, the AP MLD may accept only one additional link, keeping the total within the limit.

As depicted, the Link Reconfiguration Response frame 310-1 includes a Frame Body 350. The Frame Body 350 includes a Per-STA Profile subelement 315, which contains link-related information specific to the requesting STA MLD 105. Inside the Per-STA Profile subelement 315, there is an STA Profile field 320. Within the STA Profile field 320, three subfields are included: the Number of Links Added subfield 325, the Number of Links Deleted subfield 330, and the Status Code subfield 335. The Number of Links Added subfield 325 indicates the number of requested links that have been successfully added. The Number of Links Deleted subfield 330 specifies the number of requested links that have been successfully removed. The Status Code field 335 includes the link setup status. If at least one requested link was rejected due to exceeding the AP MLD's setup link limit, the rejection status code 340 is included in the Status Code field 335 of the Link Reconfiguration Response frame 310-1.

Upon receiving the Link Reconfiguration Response frame 310-1, the STA MLD 105 infers the maximum allowable link limit enforced by the AP MLD 110 based on the rejection status code and the number of links indicated in the response. If the response contains the rejection status code 340, the STA MLD 105 learns that at least one of the requested links has been rejected due to exceeding the AP MLD's enforced link limit. To infer the exact limit, the STA MLD 105 first considers the number of links initially established during the association phase (which was communicated in the (Re)Association Response frame). The STA MLD 105 then examines the Link Reconfiguration Response frame 310, particularly the Number of Links Added field 325 and the Number of Links Deleted field 330, to determine the final number of accepted links after reconfiguration. The STA MLD 105 concludes that the enforced link limit is equal to the sum of the number of links initially established, plus the number of links added, minus the number of links deleted after reconfiguration. For example, the STA MLD 105 initially established two links and later requested to add two more links, but the AP MLD 110 only accepted one additional link and rejected the other. The STA MLD 105 can infer that the maximum allowable link limit is three because the AP MLD 110 rejected any request beyond this number. Similarly, if the STA MLD 105 had deleted one link before requesting to add two more links, and the AP MLD only accepted one new link while rejecting the other, the STA MLD 105 can recognize that the limit is three. The rejection indicates that any further increase beyond this level is not permitted under the AP's link management policy.

In some embodiments, with the determined link limit, the STA MLD 105 may adjust its subsequent Link Reconfiguration Request and Reassociation Request accordingly. By knowing the AP's enforced limit, the STA MLD 105 may avoid sending requests that exceed the allowed number of links, which therefore minimizes request failures and reduces signaling overhead.

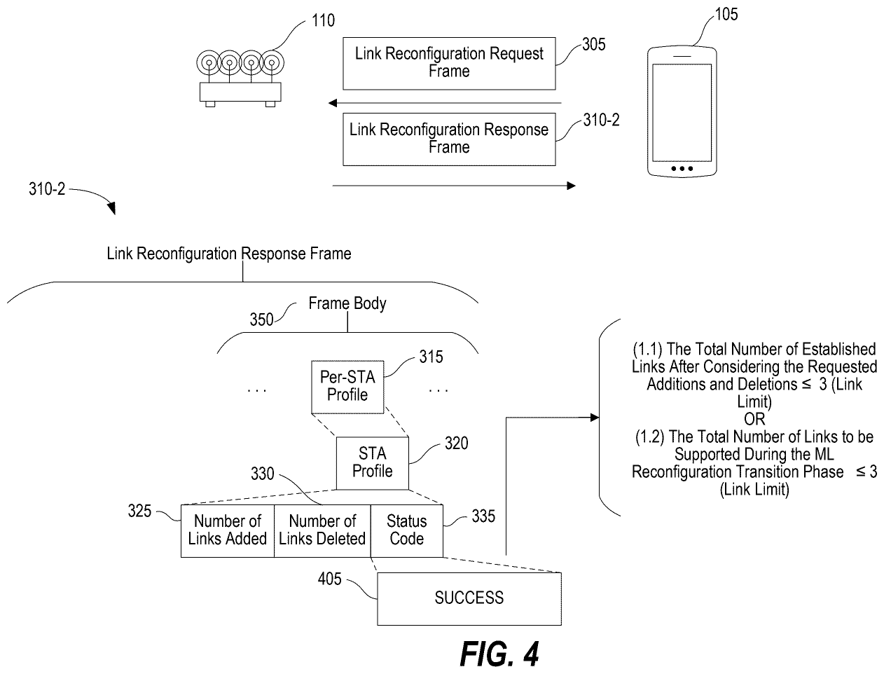

FIG. 4 depicts an example Link Reconfiguration frame 310-2 with a status code 405 indicating full acceptance of the requested links, according to some embodiments of the present disclosure.

The SUCCESS status code 405 indicates that the AP MLD 110 has fully accepted the STA MLD's 105 requested link modifications (including link additions and/or deletions). All requested links have been successfully added and/or deleted without exceeding any enforced link limits.

The SUCCESS status code 405 may be used in embodiments where the requested link modifications comply with the AP MLD's 110 link management policy. Specifically, the AP MLD 110 may include the SUCCESS code 405 when the total number of established links after considering the requested additions and deletions is within or equal to the AP's enforced link limit (e.g., 3 links). For example, if the STA MLD 105 initially has two established links and requests to add one more link, bringing the total to three, the AP MLD 110 may accept the request and send the SUCCESS code, confirming that the new configuration remains within the allowed limit.

In some embodiments, AP MLD 110 may enforce a stricter policy by considering not just the final number of established links but also the temporary total during the link reconfiguration transition process. In this configuration, the AP MLD 110 may evaluate the number of existing links that are not requested for addition, the number of links requested for deletion, and the number of links requested for addition. If the sum of these values does not exceed the link limit, the AP MLD 110 sends the SUCCESS status code 405, confirming that all requested modifications have been accepted.

As depicted, the SUCCESS status code 405 is included within the Status Code field 335, which is located in the STA Profile subfield 320 of the Per-STA Profile subelement 315, inside the Frame Body 350 of the Link Reconfiguration Response frame.

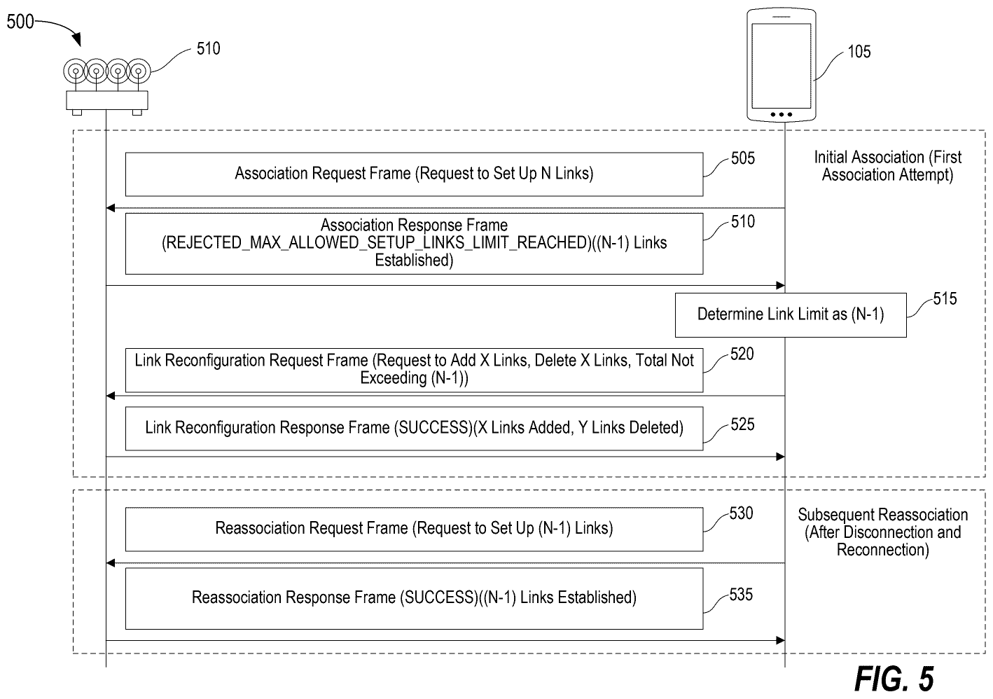

FIG. 5 depicts a set of interactions 500 between a non-AP MLD 105 and an AP MLD 110, where the non-AP MLD 105 learns the maximum allowable link limit by processing the association response frame, according to some embodiments of the present disclosure.

As depicted, the interactions begin with the initial association process, where the non-AP MLD (also referred to in some embodiments as STA MLD) 105 sends an Association Request frame 505 to AP MLD110, requesting to set up N links (e.g., 4 links). The AP MLD 110 processes the request by comparing it with its defined policy limit and other preconfigured thresholds. These thresholds include whether the AP MLD 110 advertises more than a first defined number of links (e.g., 3), whether the STA MLD 105 is requesting more links than a second defined threshold (e.g., 3), and whether the total number of already accepted links at the AP MLD 110 reaches a third defined threshold (e.g., 3). These additional conditions are evaluated to determine whether enforcing a link limit is beneficial, considering the AP MLD's available resources and network conditions. Enforcing a policy limit is applied only when the AP MLD 110 advertises a sufficient number of links, the STA MLD 105 is requesting more links than a reasonable range and may pose a risk of inefficient resource use or unfair network access, and the AP has already established a number of links and cannot accommodate additional ones without exceeding its policy-defined limit.

After evaluating these conditions and the defined policy-based link limit, the AP MLD 110 responds with an Association Response frame 510. Since the requested number of links (N) exceeds the AP MLD's enforced limit (N−1), and all other conditions are met—the AP advertising more links than the first threshold, the STA MLD requesting more links than the second threshold, and the AP MLD's already established links reaching the third threshold—the AP MLD 110 rejects one link and includes the REJECTED_MAX_ALLOWED_SETUP_LINKS_LIMIT_REACHED status code (e.g., 150 of FIG. 1) in the Association Response frame 510. The response 510 further indicates that only N−1 links are established instead of the requested N links.

Upon receiving the Association Response frame 510, the STA MLD 105 determines that its maximum allowable link limit is N−1 (as depicted by 515), as indicated in the Association Response 510. When the STA MLD 105 intends to modify the link configuration, the STA MLD 105 sends a Link Reconfiguration Request frame 520 to AP MLD 110. In this request, the STA MLD 105 requests to add X links and delete Y links. The values of X and Y may vary depending on the STA's link management strategy and network conditions. However, since the STA MLD 105 already knows the AP MLD's enforced policy limit (N−1) from the previous association response, when defining the values of X and Y, the STA MLD 105 ensures that the total number of established links after reconfiguration does not exceed N−1. In embodiments where a stricter policy is enforced by AP MLD 110, STA MLD 105 may further ensure that the total number of temporary links during the reconfiguration transition—including the number of existing setup links that are not requested for deletion, the number of setup links that are requested for deletion, and the number of setup links requested for addition—does not exceed the N−1 limit.

Since the request 520 complies with the AP MLD's link policy, the AP MLD 110 processes it and responds with a Link Reconfiguration Response frame 525 that includes a SUCCESS status code, confirming that the requested modifications have been fully accepted.

At a later time, the STA MLD 105 disconnects from the AP MLD 110 and needs to reconnect. When the STA MLD 105 attempts to reestablish the connection, the STA MLD 105 sends a Reassociation Request frame 530, only requesting N−1 links, based on the previously determined limit. Since the request does not exceed the AP's enforced setup link limit, the AP MLD 110 responds with a Reassociation Response frame 535, including a SUCCESS status code (e.g., 405 of FIG. 4). The response 535 confirms that all requested N−1 links have been successfully established.

The example interaction depicted in FIG. 5 demonstrates how the STA MLD 105 infers the AP MLD's 110 enforced policy through association signaling. By analyzing the rejection status code and the number of successfully established links in the Association Response frame 510, the STA MLD 105 determines the maximum allowable link limit set by the AP MLD 110. The STA MLD 105 then applies the inferred limit in its subsequent Link Reconfiguration and Reassociation Requests.

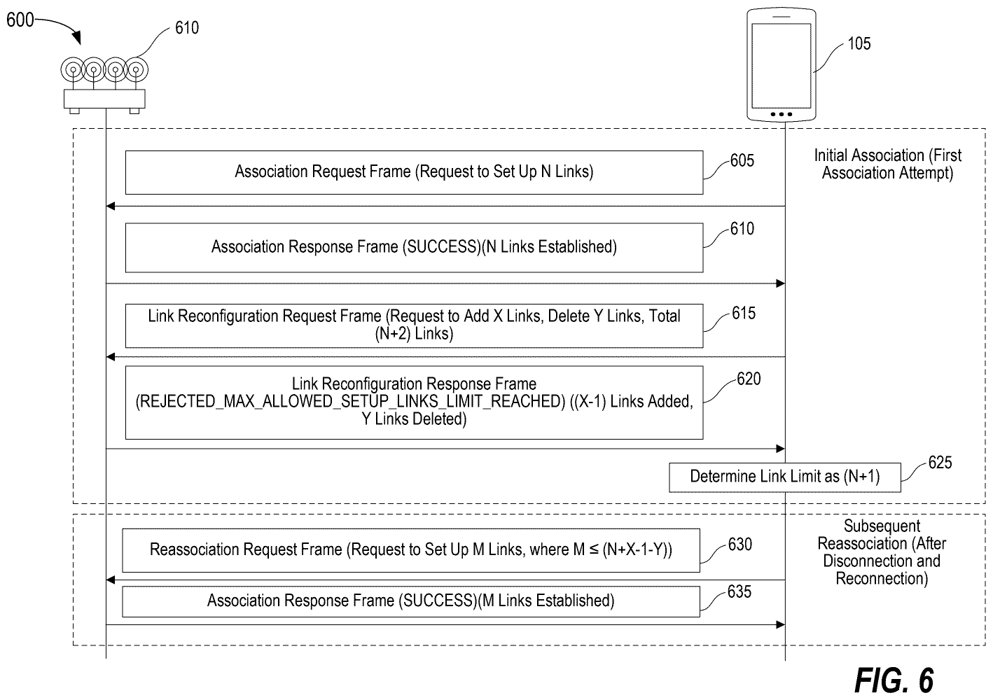

FIG. 6 depicts a set of interactions 600 between a non-AP MLD 105 and an AP MLD 110, where the non-AP MLD 105 learns the maximum allowable link limit by processing the association response frame and link reconfiguration response frame, according to some embodiments of the present disclosure.

As depicted, the non-AP MLD (also referred to in some embodiments as STA MLD) 105 sends an Association Request frame 605 to AP MLD 110, requesting to establish N links (e.g., 2 links). The AP MLD 110 processes the request and responds with an Association Response frame 610 that includes a SUCCESS status code (e.g., 205 of FIG. 2), confirming that all N requested links have been established. At this stage, the STA MLD 105 cannot infer the AP MLD's maximum allowable link limit, as there is no indication that additional links would be rejected.

Following the initial setup, the STA MLD 105 sends a Link Reconfiguration Request frame 615 to modify its link configuration. In this request, the STA MLD 105 requests to add X links and delete Y links, leading to a total of (N+X-Y) links if all requested modifications are accepted. The AP MLD 110 evaluates the request based on its predefined link limit and determines that allowing all requested modifications would exceed the enforced link limit. Based on the evaluation, the AP MLD 110 partially grants the request by accepting and establishing only X−1 of the requested X additional links, deleting all Y requested links, and including the rejection status code (e.g., 340 of FIG. 3) in the response. In some embodiments, the AP MLD 110 may apply a stricter policy, evaluating the temporary number of links during the transition phase. If the total number of links that need to be supported during the transition process-including existing links that are not requested for deletion, links requested for deletion, and links requested for addition-exceeds a defined limit (even if the final number of established links is within the limit), the AP MLD 110 may still only accept X−1 links and delete Y links to avoid the temporary links exceeding the allowed limit.

Upon receiving the response 620, the STA MLD 105 can infer the AP's link limit

(as depicted by 625). The maximum allowable number of links between AP MLD 110 and STA MLD 105 is determined as follows:

$$Limit = N + ( X - 1 ) - Y$$

The equation presents that the limit is equal to the sum of the initial number of established links (N), plus the successfully added links (X−1), minus the deleted links (Y). The rejection status code (e.g., 340 of FIG. 3) signals that attempting to establish more links than this limit would violate the AP's policy.

Following that, the STA MLD 105 disconnects from the AP MLD 110 and subsequently attempts to reconnect. When reestablishing the connection, the STA MLD 105 sends a Reassociation Request frame 630 to AP MLD 110, requesting to set up M links, where the M falls within or is equal to the inferred limit (M≤N+X−1−Y). Since the request is within the AP MLD's allowable range, the AP MLD 110 responds with a Reassociation Response frame 635, including the SUCCESS code (e.g., 405 of FIG. 4) and confirming that M links have been successfully established.

The example interaction depicted in FIG. 6 demonstrates how the STA MLD 105 infers the AP MLD's 110 enforced policy through association and link reconfiguration signaling. By analyzing the number of successfully established links in the Association Response frame 610, as well as the rejection code and the number of added links and deleted links in the Link Reconfiguration Response frame 620, the STA MLD 105 determines the maximum allowable link limit set by the AP MLD 110. The STA MLD 105 then applies the inferred limit in its subsequent reassociation requests.

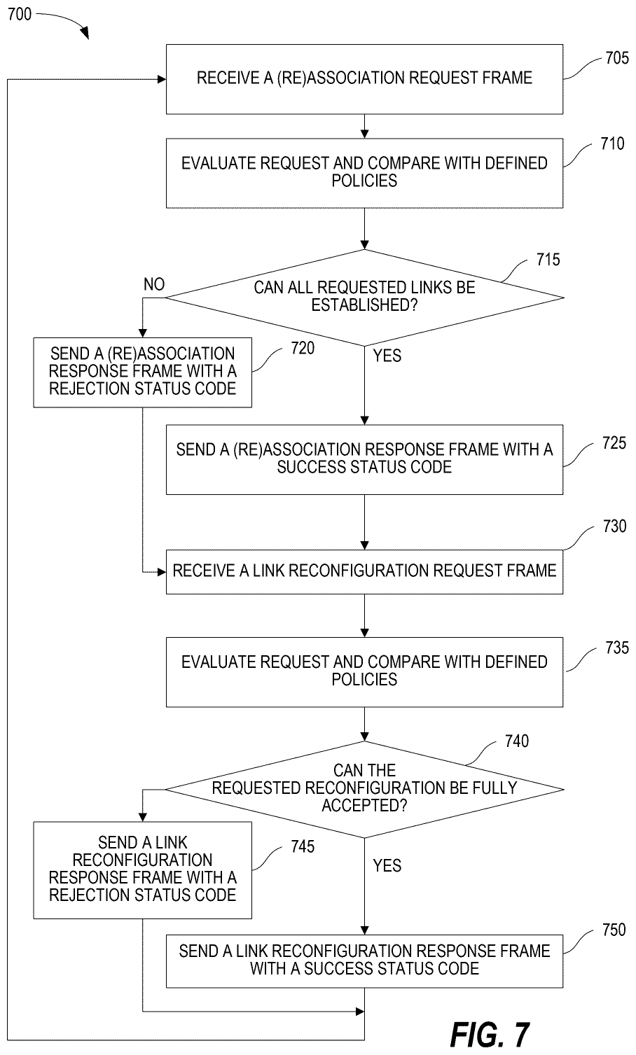

FIG. 7 depicts an example method 700 of an AP MLD processing (Re)Association and Link Reconfiguration Request frames and sending responses to signal the maximum allowable link limit, according to some embodiments of the present disclosure. In some embodiments, the method 700 may be performed by an AP MLD or any other network device capable of managing multiple STAs and supporting MLO. The AP MLD may correspond to AP MLD 110 as depicted in FIGS. 1-6.

At block 705, an AP MLD (e.g., 110 of FIGS. 1-6) receives a (Re)Association Request frame from an STA MLD (e.g., 105 of FIGS. 1-6). The request (e.g., 115 of FIGS. 1-2) may include an intent to establish N links between the STA MLD 105 and the AP MLD 110.

At block 710, the AP MLD evaluates the request and compares the number of requested links N with the defined policy limit. In some embodiments, the policy limit may be generic, applied to all STAs within the same basic service set (BSS). In some embodiments, the policy limit may be specific to each STA, such as setting two links for STA 1 while three links for STA 2. Additionally, the AP MLD may evaluate the three threshold conditions to determine whether enforcing the policy limit is beneficial. These conditions include whether the AP MLD advertises a sufficient number of links (e.g., more than a first defined threshold), whether the STA MLD requests more links than a reasonable threshold (e.g., more than a second defined threshold), and whether the AP MLD 110 has already established a number of links (e.g., more than a third defined threshold). If all these conditions are satisfied, indicating that enforcing a limit is desired (or needed), the AP MLD 110 proceeds to determine whether all requested links can be granted.

At block 715, the AP MLD determines whether all requested links in the (Re)Association Request frame can be established. If granting all requested links would not exceed the enforced limit, or the AP determines not to enforce the policy limit (due to one of the three conditions not being met), the method 700 proceeds to block 725, where the AP MLD responds with a (Re)Association response (e.g., 120-2 of FIG. 2) that includes a SUCCESS status code (e.g., 205 of FIG. 2). If enforcing a link limit is desired (or needed), and the requested links exceed the policy-defined limit, the method 700 moves to block 725, where the AP MLD sends a (Re)Association Response frame (e.g., 120-1 of FIG. 1) with the rejection status code (e.g., 150 of FIG. 1). This code indicates that at least one requested link is rejected due to exceeding the AP's allowable setup link limit. The STA can infer the policy limit based on the number of successfully established links in the response.

After the AP MLD sends the (Re)Association Response frame (either with the success code or rejection code), the method 700 moves to block 730, where the AP receives a Link Reconfiguration Request frame from the STA MLD. The request is sent when the STA remains connected and wants to modify its link configuration. In the response, the STA MLD may request to add X links and delete Y links.

At block 735, the AP MLD processes the request based on its policy limit. In one embodiment, the AP MLD may evaluate the request based on the final number of established links after modifications. If the new total does not exceed the limit, the requested links can be fully accepted. In another embodiment, the AP MLD may evaluate the total number of links during the transition phase, considering the existing setup links that are not requested for deletion, links that are requested for deletion, and links that are requested for addition. If the total exceeds the predefined limit, even temporarily, enforcement applies, and at least one requested link is rejected.

At block 740, the AP MLD determines whether the total number of links, after considering additions and deletions, remains within the allowed limit. If all requested link modifications can be granted, the method 700 proceeds to block 750, where the AP MLD sends a Link Reconfiguration Response frame (e.g., 310-2 of FIG. 4) with the SUCCESS code (e.g., 405 of FIG. 4). If some additions are rejected for exceeding the enforced limit, the method 700 moves to block 745, where the AP MLD sends a Link Reconfiguration Response frame (e.g., 310-1 of FIG. 4) with the rejection code (e.g., 340 of FIG. 3). The AP MLD may accept some of the requested links while rejecting others. For example, if the STA has 3 links, the AP's limit is 4, and the STA requests 2 more links, the AP may accept only 1 additional link to stay within the limit.

The operations at blocks 730-750 are optional and occur only when the STA MLD, within the same association phase, requests to modify its link configuration through a Link Reconfiguration Request. If no link modification is requested, the method 700 skips the operations at blocks 730-750, and moves directly from blocks 720 and 725 back to block 705 for a future reassociation attempt.

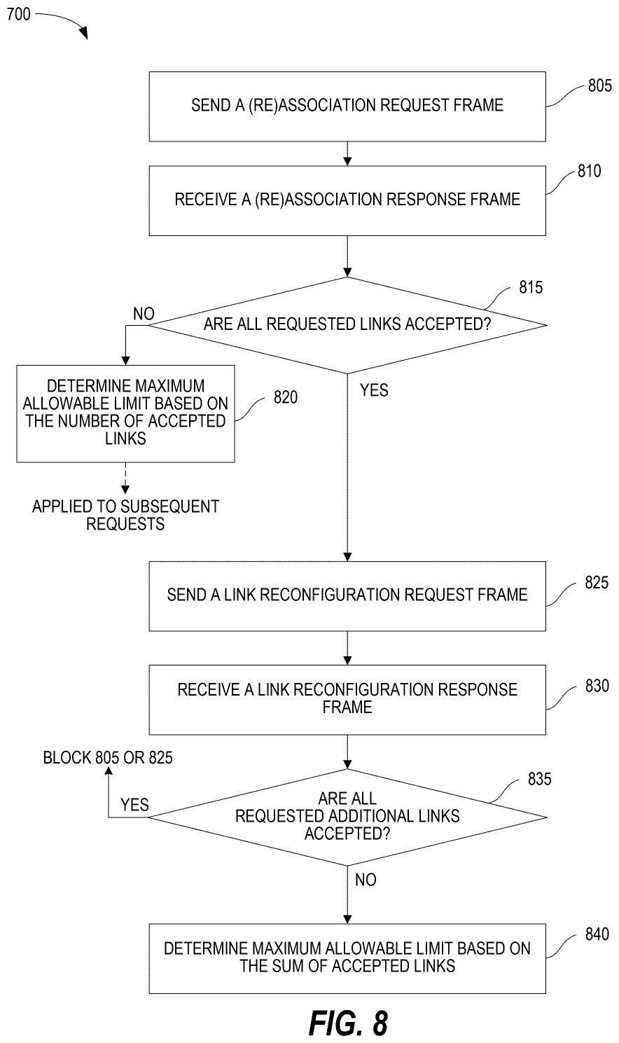

FIG. 8 depicts an example method 800 of a non-AP MLD determining the maximum allowable link limit by processing (Re)Association and Link Reconfiguration Response frames from the AP MLD, according to some embodiments of the present disclosure. In some embodiments, the method 800 may be performed by a non-AP MLD, such as STA MLD 105 as depicted in FIGS. 1-6.

At block 805, an STA MLD (e.g., 105 of FIGS. 1-6) sends a (Re) Association Request frame (e.g., 115 of FIG. 1) to an AP MLD (e.g., 110 of FIGS. 1-6), requesting to establish N links.

At block 810, the STA MLD receives an (Re)Association Response frame (e.g., 120 of FIG. 1) from the AP MLD, which includes the number of links that have been successfully established and a status code (e.g., a SUCCESS status code or a REJECTED_MAX_ALLOWED_SETUP_LINKS_LIMIT_REACHED code).

At block 815, the STA MLD checks the response. If the response includes the SUCCESS status code, indicating all requested links are accepted, the method 800 proceeds to block 825. If the response includes the rejection status code (REJECTED_MAX_ALLOWED_SETUP_LINKS_LIMIT_REACHED), indicating at least one link is rejected due to exceeding the policy limit, the method 800 proceeds to block 820.

At block 820, as the rejection code indicates that the AP enforced a link limit and at least one link is rejected due to exceeding the limit, the STA MLD infers the limit as the number of successfully established links indicated in the response. For example, if the STA MLD requests N links but the response establishes only N−1 links, with the rejection code included, the STA MLD determines that the maximum allowable link limit is N−1. The STA may then apply this limit to subsequent Link Reconfiguration and Reassociation Requests, adjusting requested link numbers to ensure it does not exceed the policy-defined limit.

At block 825, the STA MLD sends a Link Reconfiguration Request frame (e.g., 305 of FIGS. 3-4) to the AP MLD. This operation only occurs when the STA MLD intends to modify its link configuration after the initial association. The request may include an intent to add X links and/or delete Y links.

At block 830, the STA MLD receives a Link Reconfiguration Response (e.g., 310 of FIGS. 3-4) from the AP MLD. The response includes the number of links successfully added, the number of links successfully deleted, and a status code indicating whether the request was fully or partially accepted.

At block 835, the STA MLD checks the response. If the response includes a rejection code (e.g., 340 of FIG. 3), the method 800 proceeds to block 840, where the STA MLD determines the link limit as the sum of the number of initially established links, plus the number of links successfully added after reconfiguration, minus the number of links successfully deleted after reconfiguration. For example, if the STA initially established N links, and later requested to add X links and delete Y links, but the AP only accepts X−1 links, then the STA determines that the link limit is N+X−1−Y.

If the response includes a SUCCESS code (e.g., 405 of FIG. 4), indicating all requested modifications were accepted, the STA MLD cannot determine the AP's link limit because no rejection occurred. In this configuration, the method 800 cycles back to either block 805 (if a reassociation is needed) or 825 (if the STA MLD intends to make additional link modifications). The STA MLD continues to monitor responses until a rejection code is received. Upon receiving the rejection code, the STA MLD can then determine the enforced link limit. With the determined link limit, the STA MLD may adjust subsequent Link Reconfiguration and Reassociation Requests accordingly.

The operations at blocks 825-840 are optional and occur only when the STA MLD remains connected and intends to modify its existing setup links. If no link modification is requested and the connection remains stable, the method 800 skips the operations at blocks 825-840. When STA MLD intends to reconnect to the AP MLD after disconnection, the method 800 moves directly from blocks 815 and 820 back to block 805 by sending a Reassociation Request.

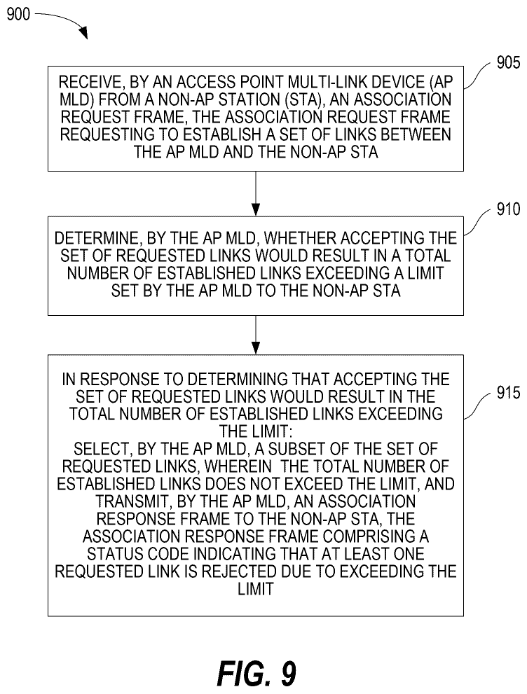

FIG. 9 is a flow diagram depicting an example method 900 for signaling a maximum allowable link limit, according to some embodiments of the present disclosure.

At block 905, an AP MLD received, from a non-AP STA (e.g., 105 of FIG. 1), an association request frame, the association request frame (e.g., 115 of FIG. 1) requesting to establish a set of links between the AP MLD and the non-AP STA.

At block 910, the AP MLD determines whether accepting the set of requested links would result in a total number of established links exceeding a limit set by the AP MLD for the non-AP STA.

At block 915, in response to determining that accepting the set of requested links would result in the total number of established links exceeding the limit, the AP MLD selects a subset of the set of requested links, where the total number of established links does not exceed the limit, and transmits an association response frame (e.g., 120-1 of FIG. 1) to the non-AP STA, the association response frame comprising a status code (e.g., 150 of FIG. 1) indicating that at least one requested link is rejected due to exceeding the limit.

In some embodiments, the AP MLD may further determine whether the AP MLD advertises a number of links larger than a first defined threshold, a number of the set of requested links exceeds a second defined threshold, and a total number of accepted links by the AP MLD exceeds a third defined threshold.

In some embodiments, the status code (e.g., 150 of FIG. 1) may be transmitted to the non-AP STA upon determining that the AP MLD advertises the number of links larger than the first defined threshold, the number of the set of requested links exceeds the second defined threshold, the total number of accepted links exceeds the third defined threshold, and accepting the set of requested links would result in the total number of established links exceeding the limit.

In some embodiments, the non-AP STA may determine a maximum allowable number of setup links with the AP MLD as equal to the total number of links established following the association response frame received from the non-AP STA.

In some embodiments, in response to determining that accepting the set of requested links would not result in the total number of established links exceeding the limit, the AP MLD may establish the set of requested links with the non-AP STA, and transmit a second association response frame (e.g., 120-2 of FIG. 2) to the non-AP STA, the second association response frame confirming a successful link establishment.

In some embodiments, the AP MLD may receive, from the non-AP STA, a link reconfiguration request frame (e.g., 305 of FIG. 3), the link reconfiguration request frame comprising at least one of a request to delete one or more links or a request to add one or more links, and determine whether adjusting link setup based on the link reconfiguration request frame would result in the total number of established links exceeding the limit set by the AP MLD to the non-AP STA. In response to the determination that adjusting link setup based on the link reconfiguration request frame would result in the total number of established links exceeding the limit, the AP MLD may reject at least one requested link addition, and transmit a link reconfiguration response frame (e.g., 310-1 of FIG. 3) to the non-AP STA, the link reconfiguration response frame comprising the status code (e.g., 340 of FIG. 3) indicating rejection due to exceeding the limit.

In some embodiments, the non-AP STA may determine a maximum allowable number of setup links with the AP MLD as a sum of a number of links established following the association response frame received from the non-AP STA, plus a number of links added following the link reconfiguration response frame received from the AP MLD, and minus a number of links deleted following the link reconfiguration response frame.

In some embodiments, the non-AP STA may generate a second association request frame (e.g., 530 of FIG. 5) for a second association procedure with the AP MLD, the second association request frame requesting to establish a second set of links between the AP MLD and the non-AP STA, and transmit the second association request frame to the AP MLD, where a number of the second set of requested links does not exceed the maximum allowable number.

In some embodiments, in response to the determination that adjusting a link setup based on the link reconfiguration request frame would result in the total number of established links falling below or equal to the limit, the AP MLD may adjust the link setup based on the link reconfiguration request frame, and transmit a second link reconfiguration response frame (e.g., 310-2 of FIG. 4) to the non-AP STA, the second link reconfiguration response frame confirming a successful link adjustment.

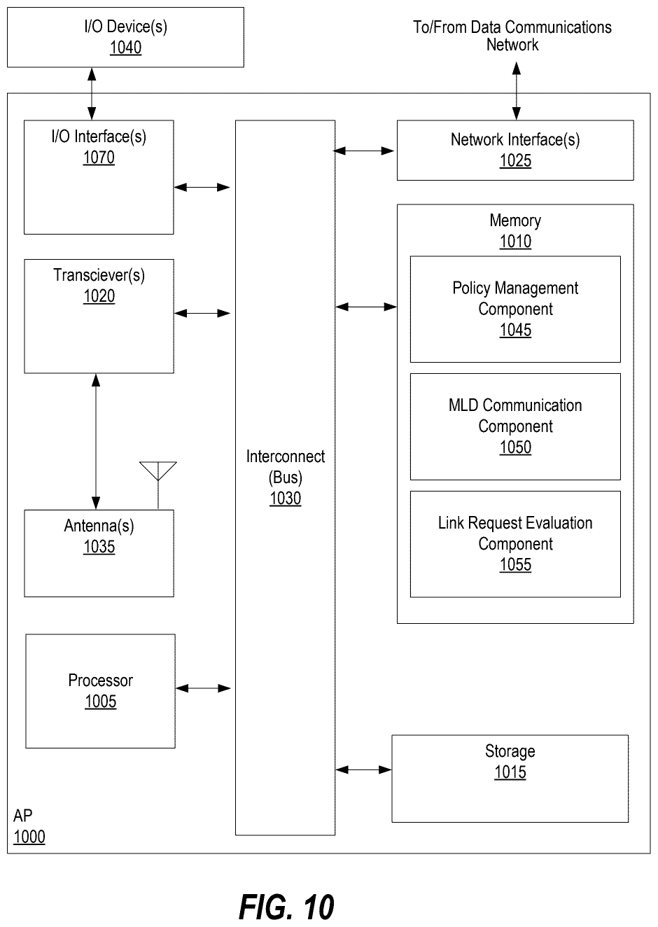

FIG. 10 depicts an example network device 1000 configured to perform various aspects of the present disclosure, according to some aspects of the present disclosure. The network device 1000 may be an AP MLD, which corresponds to AP MLD 110 as depicted in FIGS. 1-6.

As illustrated, the example network device 1000 includes a processor 1005, memory 1010, storage 1015, one or more transceivers 1020, one or more I/O interfaces 1080, and one or more network interfaces 1025. In some embodiments, I/O devices 1040 are connected via the I/O interface(s) 1080. Further, via the network interface 1025, the network device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceiver 1020, I/O interfaces 1080, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the network device 1000 to perform various functions described herein for wireless communication. In the illustrated example, the memory 1010 includes three software components: the policy management component 1045, the MLO communication component 1050, and the link request evaluation component 1055.

In one embodiment, the policy management component 1045 is configured to store and manage policy-defined link limits and other relevant thresholds. In some embodiments, the policy management component 1045 may generate global limits applicable to all STAs or STA-specific limits that vary per device. The policy management component 1045 may dynamically adjust policies based on network conditions, resource availability, or quality of service (QOS) requirements.

In one embodiment, the MLO communication component 1050 is configured to receive and process incoming (Re)Association and Link Reconfiguration Request frames from STAs, and prepare and transmit (Re)Association and Link Reconfiguration Response frames to these STAs. If all requested links are granted, the MLO communication component 1050 may include a SUCCESS status code in the response. If the request exceeds the policy-defined limit, the MLO communication component 1050 may generate a rejection response with a REJECTED_MAX_ALLOWED_SETUP_LINKS_LIMIT_REACHED status code.

In one embodiment, the link request evaluation component 1055 is configured to compare the received request against a policy-defined limit and evaluate additional conditions (e.g., whether AP advertises enough links, whether the requested links exceed a reasonable threshold, and whether the currently established links are below a threshold). The link request evaluation component 1055 may determine whether all requested links can be granted or if at least one is rejected based on the defined thresholds and enforcement policies. The link request evaluation component 1055 may then communicate the evaluation results to the MLO communication component 1050 for generating corresponding responses.

Although depicted as a discrete component for conceptual clarity, in some embodiments, the operations of the depicted components (and others not illustrated) may be combined or distributed across any number of components. Further, although depicted as software residing in memory 1010, in some aspects, the operations of the depicted components (and others not illustrated) may be implemented using hardware, software, or a combination of hardware and software.

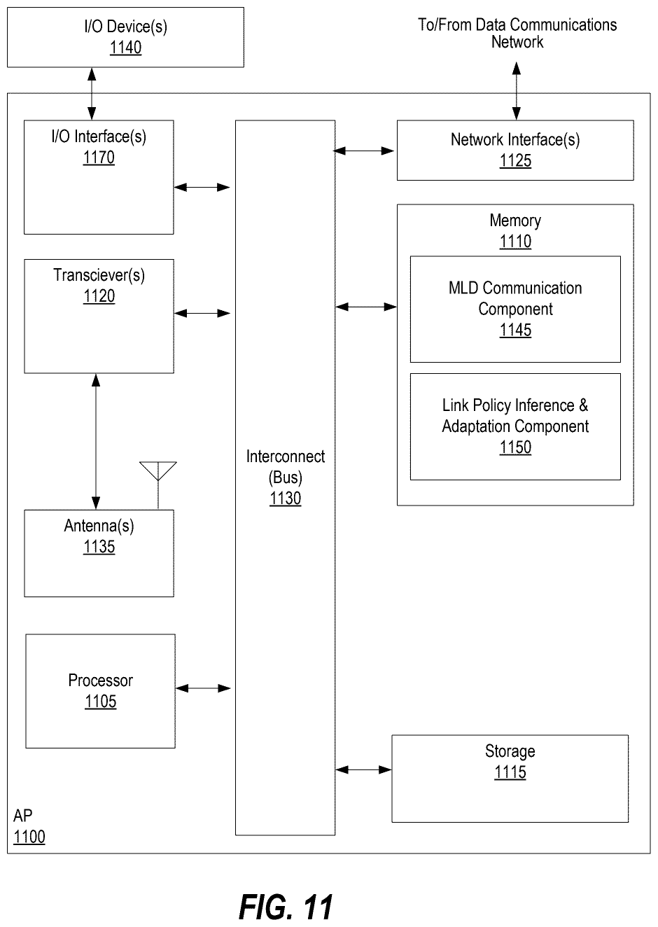

FIG. 11 depicts an example non-AP device 1100 configured to perform various aspects of the present disclosure, according to some aspects of the present disclosure. The non-AP device 1100 may be an STA MLD, which corresponds to STA MLD 105 as depicted in FIGS. 1-6.

As illustrated, the example non-AP device 1100 includes a processor 1105, memory 1110, storage 1115, one or more transceivers 1120, one or more I/O interfaces 1180, and one or more network interfaces 1125. In some embodiments, I/O devices 1140 are connected via the I/O interface(s) 1180. Further, via the network interface 1125, the non-AP device 1100 can be communicatively coupled with one or more other devices and components (e.g., via a network, which may include the Internet, local network(s), and the like). Each of the components is communicatively coupled by one or more buses 1130. In some embodiments, one or more antennas 1135 may be coupled to the transceivers 1120 for transmitting and receiving wireless signals.

The processor 1105 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1105 processes information received through the transceiver 1120, I/O interfaces 1180, and the network interfaces 1125. The processor 1105 retrieves and executes programming instructions stored in memory 1110, as well as stores and retrieves application data residing in storage 1115.

The storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1115 may store a variety of data for the efficient functioning of the system.

The memory 1110 may include random access memory (RAM) and read-only memory (ROM). The memory 1110 may store processor-executable software code containing instructions that, when executed by the processor 1005, enable the network device 1000 to perform various functions described herein for wireless communication. In the illustrated example, the memory 1110 includes two software components: the MLO communication component 1145 and the link policy inference and adaptation component 1150.

In one embodiment, the MLO communication component 1145 is configured to handle the exchange of control frames between the non-AP device 1100 and its associated AP MLD for multi-link setup and modification. The MLO communication component 1145 may generate (Re)Association Requests and Link Reconfiguration Requests, specifying the number of requested links to be established, added, or deleted. The MLO communication component 1145 may further process received response frames and extract relevant information like the number of links successfully established, added, or deleted, and included status code. Additionally, the MLO communication component 1145 may manage request retries and adjustments when a request is partially accepted or rejected due to exceeding the AP's link policy limit.

In one embodiment, the link policy inference and adaptation component 1055 is configured to interpret the status code in the (Re)Association and Link Reconfiguration Response frames and infer the enforced link limit by the AP MLD. When a rejection status code is received, the link policy inference and adaptation component 1055 determines the maximum allowable link limit based on the number of initially established links, successfully added links, and deleted links. With the determined link limit, the link policy inference and adaptation component 1055 adjusts subsequent request frames, such as (Re)Association and Link Reconfiguration Response frames, keeping the total number of requested links less than or equal to the inferred limit and preventing unnecessary rejections.

Although depicted as a discrete component for conceptual clarity, in some embodiments, the operations of the depicted components (and others not illustrated) may be combined or distributed across any number of components. Further, although depicted as software residing in memory 1110, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by an access point multi-link device (AP MLD) from a non-AP station (STA), an association request frame, the association request frame requesting to establish a set of links between the AP MLD and the non-AP STA;
determining, by the AP MLD, whether accepting the set of requested links would result in a total number of established links exceeding a limit set by the AP MLD for the non-AP STA; and
in response to determining that accepting the set of requested links would result in the total number of established links exceeding the limit:
selecting, by the AP MLD, a subset of the set of requested links, wherein the total number of established links does not exceed the limit, and
transmitting, by the AP MLD, an association response frame to the non-AP STA, the association response frame comprising a status code indicating that at least one requested link is rejected due to exceeding the limit.

2. The method of claim 1, further comprising determining, by the AP MLD, whether:
the AP MLD advertises a number of links larger than a first defined threshold,
a number of the set of requested links exceeds a second defined threshold, and
a total number of accepted links by the AP MLD exceeds a third defined threshold.

3. The method of claim 2, wherein the status code is transmitted to the non-AP STA upon determining that the AP MLD advertises the number of links larger than the first defined threshold, the number of the set of requested links exceeds the second defined threshold, the total number of accepted links exceeds the third defined threshold, and accepting the set of requested links would result in the total number of established links exceeding the limit.

4. The method of claim 1, wherein the non-AP STA determines a maximum allowable number of setup links with the AP MLD as equal to the total number of links established following the association response frame received from the non-AP STA.

5. The method of claim 1, further comprising:
in response to determining that accepting the set of requested links would not result in the total number of established links exceeding the limit:
establishing, by the AP MLD, the set of requested links with the non-AP STA, and
transmitting, by the AP MLD, a second association response frame to the non-AP STA, the second association response frame confirming a successful link establishment.

6. The method of claim 5, further comprising:
receiving, by the AP MLD from the non-AP STA, a link reconfiguration request frame, the link reconfiguration request frame comprising at least one of a request to delete one or more links or a request to add one or more links;
determining, by the AP MLD, whether adjusting link setup based on the link reconfiguration request frame would result in the total number of established links exceeding the limit set by the AP MLD to the non-AP STA; and
in response to the determination that adjusting link setup based on the link reconfiguration request frame would result in the total number of established links exceeding the limit:
rejecting, by the AP MLD, at least one requested link addition, and
transmitting, by the AP MLD, a link reconfiguration response frame to the non-AP STA, the link reconfiguration response frame comprising the status code indicating rejection due to exceeding the limit.

7. The method of claim 6, wherein the non-AP STA determines a maximum allowable number of setup links with the AP MLD as a sum of a number of links established following the association response frame received from the non-AP STA, plus a number of links added following the link reconfiguration response frame received from the AP MLD, and minus a number of links deleted following the link reconfiguration response frame.

8. The method of claim 4, wherein the non-AP STA:
generates a second association request frame for a second association procedure with the AP MLD, the second association request frame requesting to establish a second set of links between the AP MLD and the non-AP STA; and
transmits the second association request frame to the AP MLD, wherein a number of the second set of requested links does not exceed the maximum allowable number.

9. The method of claim 6, further comprising:
in response to the determination that adjusting a link setup based on the link reconfiguration request frame would result in the total number of established links falling below or equal to the limit:
adjusting, by the AP MLD, the link setup based on the link reconfiguration request frame, and
transmitting, by the AP MLD, a second link reconfiguration response frame to the non-AP STA, the second link reconfiguration response frame confirming a successful link adjustment.

10. A system of an access point multi-link device (AP MLD), comprising:
one or more computer processors; and
one or more memories collectively containing one or more programs, which, when executed by the one or more computer processors, perform an operation, the operation comprising:
receiving, by the AP MLD from a non-AP station (STA), an association request frame, the association request frame requesting to establish a set of links between the AP MLD and the non-AP STA;
determining, by the AP MLD, whether accepting the set of requested links would result in a total number of established links exceeding a limit set by the AP MLD for the non-AP STA; and
in response to determining that accepting the set of requested links would result in the total number of established links exceeding the limit:
selecting, by the AP MLD, a subset of the set of requested links, wherein the total number of established links does not exceed the limit, and
transmitting, by the AP MLD, an association response frame to the non-AP STA, the association response frame comprising a status code indicating that at least one requested link is rejected due to exceeding the limit.

11. The system of claim 10, wherein the operation further comprises determining, by the AP MLD, whether:
the AP MLD advertises a number of links larger than a first defined threshold,
a number of the set of requested links exceeds a second defined threshold, and
a total number of accepted links by the AP MLD exceeds a third defined threshold.

12. The system of claim 11, wherein the status code is transmitted to the non-AP STA upon determining that the AP MLD advertises the number of links larger than the first defined threshold, the number of the set of requested links exceeds the second defined threshold, the total number of accepted links exceeds the third defined threshold, and accepting the set of requested links would result in the total number of established links exceeding the limit.

13. The system of claim 10, wherein the non-AP STA determines a maximum allowable number of setup links with the AP MLD as equal to the total number of links established following the association response frame received from the non-AP STA.

14. The system of claim 10, wherein the operation further comprises:
in response to determining that accepting the set of requested links would not result in the total number of established links exceeding the limit:
establishing, by the AP MLD, the set of requested links with the non-AP STA, and
transmitting, by the AP MLD, a second association response frame to the non-AP STA, the second association response frame confirming a successful link establishment.

15. The system of claim 14, wherein the operation further comprises:
receiving, by the AP MLD from the non-AP STA, a link reconfiguration request frame, the link reconfiguration request frame comprising at least one of a request to delete one or more links or a request to add one or more links;
determining, by the AP MLD, whether adjusting link setup based on the link reconfiguration request frame would result in the total number of established links exceeding the limit set by the AP MLD to the non-AP STA; and
in response to the determination that adjusting link setup based on the link reconfiguration request frame would result in the total number of established links exceeding the limit:
rejecting, by the AP MLD, at least one requested link addition, and
transmitting, by the AP MLD, a link reconfiguration response frame to the non-AP STA, the link reconfiguration response frame comprising the status code indicating rejection due to exceeding the limit.

16. The system of claim 15, wherein the non-AP STA determines a maximum allowable number of setup links with the AP MLD as a sum of a number of links established following the association response frame received from the non-AP STA, plus a number of links added following the link reconfiguration response frame received from the AP MLD, and minus a number of links deleted following the link reconfiguration response frame.

17. The system of claim 13, wherein the non-AP STA:
generates a second association request frame for a second association procedure with the AP MLD, the second association request frame requesting to establish a second set of links between the AP MLD and the non-AP STA; and
transmits the second association request frame to the AP MLD, wherein a number of the second set of requested links does not exceed the maximum allowable number.

18. The system of claim 15, wherein the operation further comprises:
in response to the determination that adjusting a link setup based on the link reconfiguration request frame would result in the total number of established links falling below or equal to the limit:
adjusting, by the AP MLD, the link setup based on the link reconfiguration request frame, and
transmitting, by the AP MLD, a second link reconfiguration response frame to the non-AP STA, the second link reconfiguration response frame confirming a successful link adjustment.

19. One or more computer-readable media containing, in any combination, computer program code that, when executed by a computer system, performs an operation comprising:
receiving, by an access point multi-link device (AP MLD) from a non-AP station (STA), an association request frame, the association request frame requesting to establish a set of links between the AP MLD and the non-AP STA;
determining, by the AP MLD, whether accepting the set of requested links would result in a total number of established links exceeding a limit set by the AP MLD for the non-AP STA; and
in response to determining that accepting the set of requested links would result in the total number of established links exceeding the limit:
selecting, by the AP MLD, a subset of the set of requested links, wherein the total number of established links does not exceed the limit, and
transmitting, by the AP MLD, an association response frame to the non-AP STA, the association response frame comprising a status code indicating that at least one requested link is rejected due to exceeding the limit.

20. The one or more computer-readable media of claim 19, wherein the non-AP STA determines a maximum allowable number of setup links with the AP MLD as equal to the total number of links established following the association response frame received from the non-AP STA.
